(19) United States
(12) Patent Application Publication
(10) Pub. No.: US 2018/0196299 A1
(43) Pub. Date: Jul. 12, 2018

(54) PIXEL STRUCTURE, LIQUID CRYSTAL DISPLAY PANEL AND THE DRIVING METHOD THEREOF

(71) Applicant: Shenzhen China Star Optoelectronics Technology Co., Ltd., Shenzhen, Guangdong (CN)

(72) Inventors: Bo SUN, Shenzhen, Guangdong (CN); Xiaoling ZOU, Shenzhen, Guangdong (CN)

(73) Assignee: Shenzhen China Star Optoelectronics Technology Co., Ltd., Shenzhen, Guangdong (CN)

(21) Appl. No.: 15/115,243

(22) PCT Filed: Jul. 5, 2016
(86) PCT No.: PCT/CN2016/088494

§ 371 Date: Jul. 28, 2016

(30) Foreign Application Priority Data
Jun. 7, 2016 (CN) 201610404617.9

(51) Int. Cl. G02F 1/1362; G02F 1/1368

(52) U.S. Cl. CPC G02F 1/13624; G02F 1/1368; G02F 2201/123; G02F 2001/136295; G02F 1/136286

(57) ABSTRACT

The present application discloses a pixel structure, a liquid crystal display panel and a driving method thereof, the pixel structure includes a plurality of pixels arranged in a matrix, each pixel including a main pixel region and a sub pixel region disposed adjacent to each other, the main pixel region includes a first pixel electrode, connected to the data line through the first control switch; the second pixel includes a second pixel electrode, connected to the data line through the second control switch and first control switch; a first scanning line controlling the first control switch, a charge sharing line controlling the second control switch, and the charge sharing line is connected to a second scanning line differ from the first scanning line. By the above approach, to increase the pixel aperture ratio of the present application, not occupied the peripheral design region, and beneficial to achieve a narrow bezel.

### FIELD OF THE INVENTION

The present application relates to a liquid crystal display technology field, and more particularly to a pixel structure, liquid crystal display panel and the driving method thereof.

### BACKGROUND OF THE INVENTION

A Thin Film Transistor, TFT-Liquid Crystal Display, LCD relies on different orientation of the liquid crystal in a different electrical field, in which case, since the optical birefringence of the liquid crystal causes incident light from the backlight to the liquid crystal producing a different transmittance, thus having gray scale. The three primary of the red, green and blue color resist are placed in the optical path to get different colors, different image with light and dark. When viewing the liquid crystal display in a large viewing angle, because of the different angles, the transmittance is different in all directions above, the deviation felt are different, resulting in the color shift phenomenon discussed in the industry. To overcome this adverse innate of the liquid crystal display, a number of methods are formed. The general method for currently used is multi-domain structure, such as making the liquid crystal state in a mean similar status from the observers seen in all directions, the widely used is eight domains structure.

In order to achieve the eight domains structure, the charge sharing technology is now widely used. As illustrated in FIG. 1, a pixel 10 is divided into two sub-pixels, i.e., the main pixel 100 and a sub pixel region 101, the main pixel region 100 is driven by the thin film transistor 11, the sub pixel region 101 is driven by the sharing TFT 12. Each pixel requires two gate lines, the charge gate 13 is responsible for the thin film transistor 11 switch, the share gate 14 is responsible for sharing TFT 12 switch, this will result in reduced the pixel aperture ratio. The source electrode of the sharing TFT 12 is connected to the share capacitor 15, such that the potential of the sub pixel region 101 is pull down by the sharing TFT 12 to achieve eight domains structure. Since the share gate 14 of nth row is connected to the charge gate 13 of n+4th row in the periphery region, resulting in an area occupied to the peripheral design region, and is difficult to achieve a narrow bezel.

### SUMMARY OF THE INVENTION

The embodiment of the present application discloses a pixel structure, liquid crystal display panel and the driving method thereof to increase the pixel aperture ratio, not occupied the peripheral design region, and beneficial to achieve a narrow bezel.

The present application discloses a pixel structure includes a plurality of pixels arranged in a matrix, each pixel including a main pixel region and a sub pixel region disposed adjacent to each other, the main pixel region includes a first pixel electrode, the first pixel electrode is connected to the data line through the first control switch; the second pixel includes a second pixel electrode, the second pixel electrode is connected to the data line through the second control switch and first control switch; a first scanning line controlling the first control switch, a charge sharing line controlling the second control switch, and the charge sharing line is connected to a second scanning line differ from the first scanning line.

Wherein a first through hole is disposed in the gate electrode of the second control switch, a second through hole is disposed in the second scanning line, the charge sharing line is connected to the gate electrode of the second control switch through the first through hole; the charge sharing line is connected to the second scanning line through the second through hole.

Wherein the charge sharing line is ITO thin film, and can be patterned by adaption of the same mask with the first pixel electrode, the second pixel electrode in the production process.

Wherein the pixel structure further including a first pixel and a second pixel adjacent to each other and share the first scanning line, a gate electrode of a second control switch of the first pixel is the same with a gate electrode of a second control switch of the second pixel, and the direction of the opening of a first control switch of the first pixel is opposite to the direction of the opening of a first control switch of the second pixel.

Wherein the pixel structure further including a third pixel and a fourth pixel adjacent to each other the share the first scanning line, the third pixel is adjacent to the second pixel, the data lines of the second pixel and the third pixel are in parallel together, the gate electrode of the second control switch are shared by the third pixel and the fourth pixel.

Wherein the pixel structure further including a fifth pixel and a plurality of pixels adjacent to and share a data line with the fifth pixel, a first through hole is disposed on a gate electrode of a second control switch of the plurality of pixels, a second through hole is disposed a scanning line of the fifth pixel to makes the gate electrode of the second control switch is connected to the charge sharing line through the first through hole, the charge sharing line is connected to the scanning line of the fifth pixel through the second through hole, wherein the fifth pixel is adjacent to one of the plurality of pixels.

Wherein the number of the plurality of pixels is selected at least from one of the 1, 2, 3, 4.

Wherein the main pixel region and the sub pixel region are disposed on the array substrate, the array substrate including a plurality of scanning lines formed laterally and a plurality of data lines formed longitudinally, the scanning lines and the data lines are intersect, wherein the main pixel region and the sub pixel region of the 2n−1th pixel of the plurality of the pixels, and the main pixel region and the sub pixel region of the 2nth pixel of the plurality of the pixels are deposited in the region surrounded by the 2n−1th scanning line, the 2nth scanning line, the 2n−1th data line and the 2nth data line, n is a positive integer.

A liquid crystal display panel is also provided in the present, the liquid crystal display panel including a pixel structure, wherein the pixel structure including a plurality of pixels arranged in a matrix, each pixel including a main pixel region and a sub pixel region disposed adjacent to each other, the main pixel region including a first pixel electrode, the first pixel electrode is connected to a data line through a first control switch; the sub pixel region including a second pixel electrode, the second pixel electrode is connected to a data line through the second control switch and first control switch; and a first scanning line controlling the first control switch, a charge sharing line controlling the second control switch, and the charge sharing line is connected to a second scanning line differ from the first scanning line.

Wherein a first through hole is disposed in the gate electrode of the second control switch, a second through hole is disposed in the second scanning line, the charge sharing line is connected to the gate electrode of the second control switch through the first through hole; the charge sharing line is connected to the second scanning line through the second through hole.

Wherein the charge sharing line is ITO thin film, and can be patterned by adaption of the same mask with the first pixel electrode, the second pixel electrode in the production process.

Wherein the pixel structure further including a first pixel and a second pixel adjacent to each other and share the first scanning line, a gate electrode of a second control switch of the first pixel is the same with a gate electrode of a second control switch of the second pixel, and the direction of the opening of a first control switch of the first pixel is opposite to the direction of the opening of a first control switch of the second pixel.

Wherein the pixel structure further including a third pixel and a fourth pixel adjacent to each other the share the first scanning line, the third pixel is adjacent to the second pixel, the data lines of the second pixel and the third pixel are in parallel together, the gate electrode of the second control switch are shared by the third pixel and the fourth pixel.

Wherein the pixel structure further including a fifth pixel and a plurality of pixels adjacent to and share a data line with the fifth pixel, a first through hole is disposed on a gate electrode of a second control switch of the plurality of pixels, a second through hole is disposed a scanning line of the fifth pixel to makes the gate electrode of the second control switch is connected to the charge sharing line through the first through hole, the charge sharing line is connected to the scanning line of the fifth pixel through the second through hole, wherein the fifth pixel is adjacent to one of the plurality of pixels.

Wherein the number of the plurality of pixels is selected at least from one of the 1, 2, 3, 4.

Wherein the main pixel region and the sub pixel region are disposed on the array substrate, the array substrate including a plurality of scanning lines formed laterally and a plurality of data lines formed longitudinally, the scanning lines and the data lines are intersect, wherein the main pixel region and the sub pixel region of the 2n−1th pixel of the plurality of the pixels, and the main pixel region and the sub pixel region of the 2nth pixel of the plurality of the pixels are deposited in the region surrounded by the 2n−1th scanning line, the 2nth scanning line, the 2n−1th data line and the 2nth data line, n is a positive integer.

The application also discloses a driving method for driving the liquid crystal display panel, the liquid crystal display panel including a pixel structure, wherein the pixel structure including a plurality of pixels arranged in a matrix, each pixel including a main pixel region and a sub pixel region disposed adjacent to each other, the main pixel region including a first pixel electrode, the first pixel electrode is connected to a data line through a first control switch; the sub pixel region including a second pixel electrode, the second pixel electrode is connected to a data line through the second control switch and first control switch; and a first scanning line controlling the first control switch, a charge sharing line controlling the second control switch, and the charge sharing line is connected to a second scanning line differ from the first scanning line; the driving method for driving the liquid crystal display panel including: turning on the first control switch by the control of the first scanning line; charging the main pixel region through the data line and makes the first pixel electrode having a first potential; turning on the second control switch by the control of the charge sharing line to achieve charge sharing.

By the approach mentioned above, the advantage of the present application is: the pixel structure of the present application includes a plurality of pixels arranged in a matrix, each pixel including a main pixel region and a sub pixel region disposed adjacent to each other, the main pixel region includes a first pixel electrode, the first pixel electrode is connected to the data line through the first control switch; the second pixel includes a second pixel electrode, the second pixel electrode is connected to the data line through the second control switch and first control switch; a first scanning line controlling the first control switch, a charge sharing line controlling the second control switch, and the charge sharing line is connected to a second scanning line differ from the first scanning line to increase the pixel aperture ratio, not occupied the peripheral design region, and beneficial to achieve a narrow bezel.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a schematic structure of a pixel structure in the conventional technology;

FIG. 2 is a schematic structure of a liquid crystal display panel according to an embodiment of the present application;

FIG. 3 is a schematic structure of a pixel structure according to the first embodiment of the present application;

FIG. 4 is a schematic structure of a pixel structure according to the second embodiment of the present application; and

FIG. 5 is schematic flow diagram of a driving method of the liquid crystal display panel according to an embodiment of the present application.

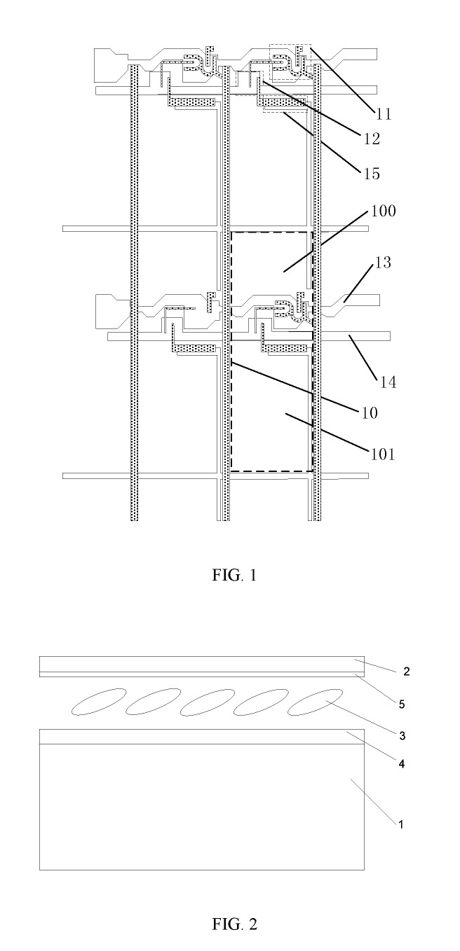

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

FIG. 2 is a schematic structure of a liquid crystal display panel according to an embodiment of the present application. As illustrated in FIG. 2, the liquid crystal display panel includes an array substrate 1, a color filter substrate 2 disposed opposite to the array substrate 1 and a liquid crystal layer 3 sandwiched between the array substrate 1 and the color filter substrate 2, a pixel electrode 4 is disposed on the array substrate 1, a common electrode 5 is disposed on the color filter substrate 2. The structure formed by the pixel electrode 4 on the array substrate 1 is a pixel structure.

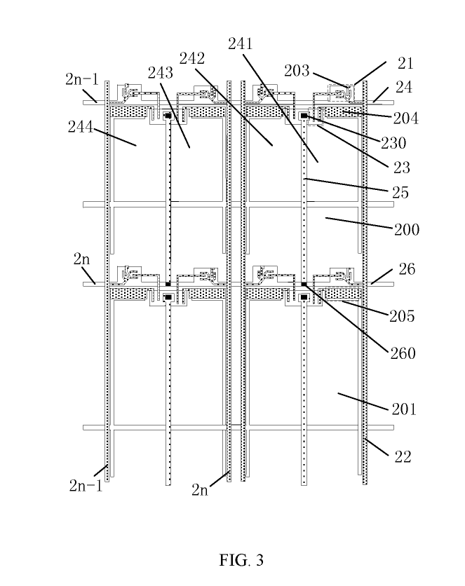

Referring to FIG. 3, the pixel structure includes a plurality of pixels arranged in a matrix, each pixel including a main pixel region 200 and a sub pixel region 201 disposed adjacent to each other. The main pixel region 200 and the sub pixel region 201 are disposed on the array substrate 1. The array substrate 1 also includes a plurality of scanning lines formed laterally and a plurality of data lines formed longitudinally, the scanning lines and the data lines are intersect. Wherein the main pixel region 200 and the sub pixel region 201 of the 2n−1th pixel of the plurality of the pixels, and the main pixel region 200 and the sub pixel region 201 of the 2nth pixel of the plurality of the pixels are deposited in the region surrounded by the 2n−1th scanning line, the 2nth scanning line, the 2n−1th data line and the 2nth data line, n is a positive integer.

The main pixel region 200 includes a first pixel electrode 203; the first pixel electrode 203 is connected to the data line 22 through the first control switch 21.

The sub pixel region 201 includes a second pixel electrode 204, the second pixel electrode 204 is connected to the data line 22 through the second control switch 23 and the first control switch 21. The source electrode or the drain electrode of the second control switch 23 and the scanning line form a share capacitor 205. A first scanning line 24 controls the first control switch 21, a charge sharing line 25 controls the second control switch 23. The charge sharing line 25 is connected to a second scanning line 26 different from the first scanning line 24. Wherein the charge sharing line 25 is ITO thin film, and can be patterned by adaption of the same mask with the first pixel electrode 203, the second pixel electrode 204 in the production process. Of course, the charge sharing line 25 can also be formed by other conductors, as long as with low resistivity.

In the embodiment of the present application, a first through hole 230 is disposed on the gate electrode of the second control switch 23, a second through hole 260 is disposed on the second scanning line 26, the charge sharing line 25 is connected to the gate electrode of the second control switch 23 through the first through hole 230. The charge sharing line 25 is connected to the second scanning line 26 through the second through hole 260. Referring to FIG. 3, the second scanning line 26 can be a scanning line adjacent to the first scanning line 24, so that the second control switch 23 and the first control switch controlled by the adjacent second scanning line 26 can turn on simultaneously to achieve the goal of charge sharing.

Therefore, the arrangement of the data lines of the embodiment of the present application differs from the conventional 1G1D manner, the data lines in the embodiment of the present application are arranged side by side of the two adjacent rows of the pixels, the opening direction of the adjacent first control switch and the second control switch is in contrast. The charge sharing line of the pixel in the nth row is connected to the scanning line of the pixel in the n+1th row in internal side by the design of the through hole, it can make the second control switch of the pixel in the nth row and the first control switch of the pixel in the n+1th row turn on simultaneously to achieve the goal of charge sharing and realize reducing the effect of color shift. Wherein the first through hole is connected to the charge sharing line and the gate electrode of the second control switch of the pixel in the nth row, the second through hole is connected to the charge sharing line and the scanning line of the pixel in the n+1th row. The charge sharing line is a ITO thin film, by adaption of the design, a layer of ITO thin film with a scanning line potential is formed on the data line, it makes the data line loading of the data line is larger, so the data line need to be rearrange, referring to FIG. 3. Thus, there is no data line below the ITO thin film used for connection, the data line loading of the data lines will not cause, and this design just need the two pixels in adjacent rows share the ITO thin film for connection, and without the need to connect each pixels of each row with a separate row of a ITO thin film, reducing the number of the through-holes.

The specific arrangement of the data line can be refer to FIG. 3, the pixel structure includes a first pixel 241 and a second pixel 242 adjacent to each other and share the first scanning line 24, the gate electrode of the second control switch of the first pixel 241 is the same with the gate electrode of the second control switch of the second pixel 242, and all connected to the charge sharing line 25 through the first through hole 230. The direction of the opening of the first control switch of the first pixel 241 is opposite to the direction of the opening of the first control switch of the second pixel 242. The pixel structure further includes a third pixel 243 and a fourth pixel 244 adjacent to each other the share the first scanning line 24, the third pixel 243 is adjacent to the second pixel 242, the data lines of the second pixel 242 and the third pixel 243 are in parallel together, the gate electrode of the second control switch are shared by the third pixel 243 and the fourth pixel 244. The plurality of the pixels to share the first scanning line 24 is arranged in the period as the first pixel 241, the second pixel 242, the third pixel 243, and the fourth pixel 244.

In addition, the second control switch in the Nth row and the first control switch in the N+1th row are open simultaneously. In this way can make the area occupied by the original charge sharing line reduced significantly, and is beneficial to improve the aperture ratio of the pixel. Since the charge sharing line in the Nth row is connected to the first scanning line in internal side, there is no need to occupy the peripheral design region, and is beneficial to achieve a narrow bezel and in this way does not require additional mask.

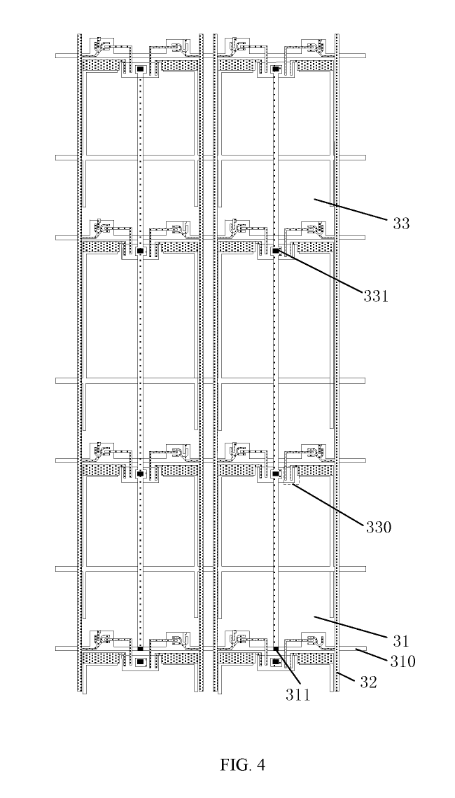

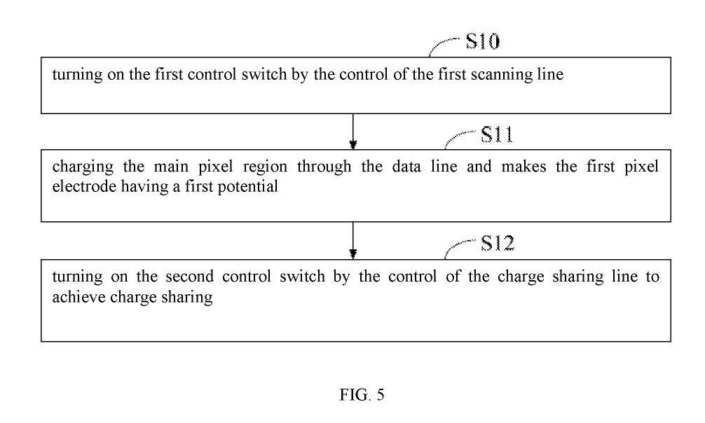

In the embodiment of the present application, a plurality of adjacent pixels shares a charge sharing line. Referring to FIG. 4, the pixel structure includes a fifth pixel 31 and a plurality of pixels 33 adjacent to and shares the common data line 32 with the fifth pixel 31. A first through hole 331 is disposed on the gate electrode of the second control switch 330 of the plurality of pixels 33, a second through hole 311 is disposed on the scanning line 310 of the fifth pixel 31 to makes the gate electrode of the second control switch 330 is connected to the charge sharing line 332 through the first through hole 331. The charge sharing line is connected to the scanning line 310 of the fifth pixel 31 through the second through hole 311. Wherein the fifth pixel 31 is adjacent to one of the plurality of pixels 33. As illustrated in FIG. 4, the three successive adjacent pixels 33, 34, 35 share a charge sharing line 332. Such that the first through holes are disposed in all of the gate electrode of the second control switches of the pixels 33, 34, 35, so that the corresponding gate electrode of the second control switches are connected to the charge sharing line 332 through the first through hole. Thus, with each four rows of pixels for a period, the scanning line of the fourth row of the pixels is adapted to control the gate electrode of the second control switches of the former three rows of pixels, and the pixel number corresponding to share the charge sharing line is three. In other embodiments of the present application, the number of the plurality of pixels share the charge sharing line is selected at least from one of the 1, 2, 3, 4. In addition, the corresponding period of the pixel structure is 2, 3, 4, 5. The corresponding number of pixels of the gate electrode of the second control switches controlled by the scanning line of one pixel should not be more, or it will result in the heavy data line loading.

FIG. 5 is schematic flow diagram of a driving method of the liquid crystal display panel according to an embodiment of the present application. The liquid crystal display panel includes the pixel structure; the pixel structure includes a plurality of pixels arranged in a matrix. Each pixel includes a main pixel region and a sub pixel region adjacent formed. The main pixel region includes a first pixel electrode; the first pixel electrode is connected to a data line through a first control switch. The second pixel includes a second pixel electrode; the second pixel electrode is connected to the data line through a second control switch and the first control switch. The first scanning line controls the first control switch, a charge sharing line controls the second control switch, the charge sharing line is connected to a second scanning line different from the first scanning line. As illustrated in FIG. 5, the driving method to the liquid crystal display panel including:

Step S10: turning on the first control switch by the control of the first scanning line; wherein the first scanning line is the scanning line corresponding to the first pixel electrode.

Step S11: charging the main pixel region through the data line and makes the first pixel electrode having a first potential.

Step S12: turning on the second control switch by the control of the charge sharing line to achieve charge sharing.

Wherein the charge sharing line is ITO thin film, and can be patterned by adaption of the same mask with the first pixel electrode, the second pixel electrode in the production process. Of course, other conductors can also form the charge sharing line, as long as with low resistivity.

In the embodiment of the present application, a first through hole is disposed on the gate electrode of the second control switch, a second through hole is disposed on the second scanning line, and the charge sharing line is connected to the gate electrode of the second control switch through the first through hole. The charge sharing line is connected to the second scanning line through the second through hole. The second scanning line can be a scanning line adjacent to the first scanning line, so that the second control switch and the first control switch controlled by the adjacent second scanning line can turn on simultaneously to achieve the goal of charge sharing.

The arrangement of the data lines of the embodiment of the present application differs from the conventional 1G1D manner, the data lines in the embodiment of the present application are arranged side by side of the two adjacent rows of the pixels, the opening direction of the adjacent first control switch and the second control switch is in contrast. The charge sharing line of the pixel in the nth row is connected to the scanning line of the pixel in the n+1th row in internal side by the design of the through hole, it can make the second control switch of the pixel in the nth row and the first control switch of the pixel in the n+1th row turn on simultaneously to achieve the goal of charge sharing and realize reducing the effect of color shift. Wherein the first through hole is connected to the charge sharing line and the gate electrode of the second control switch of the pixel in the nth row, the second through hole is connected to the charge sharing line and the scanning line of the pixel in the n+1th row. The charge sharing line is a ITO thin film, by adaption of the design, a layer of ITO thin film with a scanning line potential is formed on the data line, it makes the data line loading of the data line is larger, so the data line need to be rearrange. Thus, there is no data line below the ITO thin film used for connection, the data line loading of the data lines will not cause, and this design just need the two pixels in adjacent rows share the ITO thin film for connection, and without the need to connect each pixels of each row with a separate row of a ITO thin film, reducing the number of the through-holes.

In addition, the second control switch in the Nth row and the first control switch in the N+1th row are open simultaneously. In this way can make the area occupied by the original charge sharing line reduced significantly, and is beneficial to improve the aperture ratio of the pixel. Since the charge sharing line in the Nth row is connected to the first scanning line in internal side, there is no need to occupy the peripheral design region, and is beneficial to achieve a narrow bezel and in this way does not require additional mask.

In the embodiment of the present application, the pixel structure includes a first pixel and a second pixel adjacent to each other and share the first scanning line, the gate electrode of the second control switch of the first pixel is the same with the gate electrode of the second control switch of the second pixel, and all connected to the charge sharing line through the first through hole. The direction of the opening of the first control switch of the first pixel is opposite to the direction of the opening of the first control switch of the second pixel. The pixel structure further includes a third pixel and a fourth pixel adjacent to each other the share the first scanning line, the third pixel is adjacent to the second pixel, the data lines of the second pixel and the third pixel are in parallel together, the gate electrode of the second control switch are shared by the third pixel and the fourth pixel. The plurality of the pixels to share the first scanning line are arranged in the period as the first pixel, the second pixel, the third pixel, and the fourth pixel.

In the embodiment of the present application, a plurality of adjacent pixels shares a charge sharing line. The pixel structure includes a fifth pixel and a plurality of pixels adjacent to and shares the data line with the fifth pixel. A first through hole is disposed on the gate electrode of the second control switch of the plurality of pixels; a second through hole is disposed on the scanning line of the fifth pixel to makes the gate electrode of the second control switch is connected to the charge sharing line through the first through hole. The charge sharing line is connected to the scanning line of the fifth pixel through the second through hole. Wherein the fifth pixel is adjacent to one of the plurality of pixels. The three successive adjacent pixels share a charge sharing line. Such that the first through holes are disposed in all of the gate electrode of the second control switches of the pixels, so that the corresponding gate electrode of the second control switches are connected to the charge sharing line through the first through hole. Thus, with each four rows of pixels for a period, the scanning line of the fourth row of the pixels is adapted to control the gate electrode of the second control switches of the former three rows of pixels, and the pixel number corresponding to share the charge sharing line is three. In other embodiments of the present application, the number of the plurality of pixels share the charge sharing line is selected at least from one of the 1, 2, 3, 4. In addition, the corresponding period of the pixel structure is 2, 3, 4, 5. The corresponding number of pixels of the gate electrode of the second control switches controlled by the scanning line of one pixel should not be more, or it will result in the heavy data line loading.

In summary, the pixel structure of the present application includes a plurality of pixels arranged in a matrix, each pixel including a main pixel region and a sub pixel region disposed adjacent to each other, the main pixel region includes a first pixel electrode, the first pixel electrode is connected to the data line through the first control switch; the sub pixel region includes a second pixel electrode, the second pixel electrode is connected to the data line through the second control switch and first control switch; the gate electrode of the first control switch is connected to the first scanning line, the gate electrode of the second control switch is connected to the charge sharing line, the charge sharing line is adjacent to the first scanning line, thereof to increase the pixel aperture ratio, not occupied the peripheral design region, and beneficial to achieve a narrow bezel.

Above are embodiments of the present application, which does not limit the scope of the present application. Any modifications, equivalent replacements or improvements within the spirit and principles of the embodiment described above should be covered by the protected scope of the invention.

What is claimed is:

1. A the pixel structure, wherein the pixel structure comprising a plurality of pixels arranged in a matrix, each pixel comprising a main pixel region and a sub pixel region disposed adjacent to each other, the main pixel region comprising a first pixel electrode, the first pixel electrode is connected to a data line through a first control switch; the sub pixel region comprising a second pixel electrode, the second pixel electrode is connected to a data line through the second control switch and first control switch; and
a first scanning line controlling the first control switch, a charge sharing line controlling the second control switch, and the charge sharing line is connected to a second scanning line differ from the first scanning line.

2. The pixel structure according to claim 1, wherein a first through hole is disposed in the gate electrode of the second control switch, a second through hole is disposed in the second scanning line, the charge sharing line is connected to the gate electrode of the second control switch through the first through hole; the charge sharing line is connected to the second scanning line through the second through hole.

3. The pixel structure according to claim 2, wherein the charge sharing line is ITO thin film, and can be patterned by adaption of the same mask with the first pixel electrode, the second pixel electrode in the production process.

4. The pixel structure according to claim 1, wherein the pixel structure further comprising a first pixel and a second pixel adjacent to each other and share the first scanning line, a gate electrode of a second control switch of the first pixel is the same with a gate electrode of a second control switch of the second pixel, and the direction of the opening of a first control switch of the first pixel is opposite to the direction of the opening of a first control switch of the second pixel.

5. The pixel structure according to claim 4, wherein the pixel structure further comprising a third pixel and a fourth pixel adjacent to each other the share the first scanning line, the third pixel is adjacent to the second pixel, the data lines of the second pixel and the third pixel are in parallel together, the gate electrode of the second control switch are shared by the third pixel and the fourth pixel.

6. The pixel structure according to claim 1, wherein the pixel structure further comprising a fifth pixel and a plurality of pixels adjacent to and share a data line with the fifth pixel, a first through hole is disposed on a gate electrode of a second control switch of the plurality of pixels, a second through hole is disposed a scanning line of the fifth pixel to makes the gate electrode of the second control switch is connected to the charge sharing line through the first through hole, the charge sharing line is connected to the scanning line of the fifth pixel through the second through hole, wherein the fifth pixel is adjacent to one of the plurality of pixels.

7. The pixel structure according to claim 6, wherein the number of the plurality of pixels is selected at least from one of the 1, 2, 3, 4.

8. The pixel structure according to claim 1, wherein the main pixel region and the sub pixel region are disposed on the array substrate, the array substrate comprising a plurality of scanning lines formed laterally and a plurality of data lines formed longitudinally, the scanning lines and the data lines are intersect, wherein
the main pixel region and the sub pixel region of the 2n−1th pixel of the plurality of the pixels, and the main pixel region and the sub pixel region of the 2nth pixel of the plurality of the pixels are deposited in the region surrounded by the 2n−1th scanning line, the 2nth scanning line, the 2n−1th data line and the 2nth data line, n is a positive integer.

9. A liquid crystal display panel, the liquid crystal display panel comprising a pixel structure, wherein the pixel structure comprising a plurality of pixels arranged in a matrix, each pixel comprising a main pixel region and a sub pixel region disposed adjacent to each other, the main pixel region comprising a first pixel electrode, the first pixel electrode is connected to a data line through a first control switch; the sub pixel region comprising a second pixel electrode, the second pixel electrode is connected to a data line through the second control switch and first control switch; and
a first scanning line controlling the first control switch, a charge sharing line controlling the second control switch, and the charge sharing line is connected to a second scanning line differ from the first scanning line.

10. The liquid crystal display panel according to claim 9, wherein a first through hole is disposed in the gate electrode of the second control switch, a second through hole is disposed in the second scanning line, the charge sharing line is connected to the gate electrode of the second control switch through the first through hole; the charge sharing line is connected to the second scanning line through the second through hole.

11. The liquid crystal display panel according to claim 10, wherein the charge sharing line is ITO thin film, and can be patterned by adaption of the same mask with the first pixel electrode, the second pixel electrode in the production process.

12. The liquid crystal display panel according to claim 9, wherein the pixel structure further comprising a first pixel and a second pixel adjacent to each other and share the first scanning line, a gate electrode of a second control switch of the first pixel is the same with a gate electrode of a second control switch of the second pixel, and the direction of the opening of a first control switch of the first pixel is opposite to the direction of the opening of a first control switch of the second pixel.

13. The liquid crystal display panel according to claim 12, wherein the pixel structure further comprising a third pixel and a fourth pixel adjacent to each other the share the first scanning line, the third pixel is adjacent to the second pixel, the data lines of the second pixel and the third pixel are in parallel together, the gate electrode of the second control switch are shared by the third pixel and the fourth pixel.

14. The liquid crystal display panel according to claim 9, wherein the pixel structure further comprising a fifth pixel and a plurality of pixels adjacent to and share a data line with the fifth pixel, a first through hole is disposed on a gate electrode of a second control switch of the plurality of pixels, a second through hole is disposed a scanning line of the fifth pixel to makes the gate electrode of the second control switch is connected to the charge sharing line through the first through hole, the charge sharing line is connected to the scanning line of the fifth pixel through the second through hole, wherein the fifth pixel is adjacent to one of the plurality of pixels.

15. The liquid crystal display panel according to claim 14, wherein the number of the plurality of pixels is selected at least from one of the 1, 2, 3, 4.

16. The liquid crystal display panel according to claim 9, wherein the main pixel region and the sub pixel region are disposed on the array substrate, the array substrate comprising a plurality of scanning lines formed laterally and a plurality of data lines formed longitudinally, the scanning lines and the data lines are intersect, wherein
the main pixel region and the sub pixel region of the 2n−1th pixel of the plurality of the pixels, and the main pixel region and the sub pixel region of the 2nth pixel of the plurality of the pixels are deposited in the region surrounded by the 2n−1th scanning line, the 2nth scanning line, the 2n−1th data line and the 2nth data line, n is a positive integer.

17. A driving method for driving the liquid crystal display panel, the liquid crystal display panel comprising a pixel structure, wherein the pixel structure comprising a plurality of pixels arranged in a matrix, each pixel comprising a main pixel region and a sub pixel region disposed adjacent to each other, the main pixel region comprising a first pixel electrode, the first pixel electrode is connected to a data line through a first control switch; the sub pixel region comprising a second pixel electrode, the second pixel electrode is connected to a data line through the second control switch and first control switch; and a first scanning line controlling the first control switch, a charge sharing line controlling the second control switch, and the charge sharing line is connected to a second scanning line differ from the first scanning line; the driving method for driving the liquid crystal display panel comprising:
turning on the first control switch by the control of the first scanning line;
charging the main pixel region through the data line and makes the first pixel electrode having a first potential;
turning on the second control switch by the control of the charge sharing line to achieve charge sharing.
